(19) United States
(12) Patent Application Publication
(10) Pub. No.: US 2024/0223510 A1
(43) Pub. Date: Jul. 4, 2024

(54) SCALABLE LEADERSHIP ELECTION IN A MULTI-PROCESSING COMPUTING ENVIRONMENT

(71) Applicant: Nutanix, Inc., San Jose, CA (US)

(72) Inventors: Karan GUPTA, San Jose, CA (US); Pavan Kumar KONKA, Milpitas, CA (US); Parthasarathy RAMACHANDRAN, Palo Alto, CA (US); Arun OLAPPAMANNA VASUDEVAN, Kirkland, WA (US); Andrey Alexseyevich PYATKOV, Seattle, CA (US)

(73) Assignee: Nutanix, Inc., San Jose, CA (US)

(21) Appl. No.: 18/531,605

(22) Filed: Dec. 6, 2023

Related U.S. Application Data
(63) Continuation of application No. 17/646,480, filed on Dec. 29, 2021, now Pat. No. 11,888,599.
Application No. 17/646,480 is a continuation of application No. 15/160,347, filed on May 20, 2016, now Pat. No. 11,218,418.

(51) Int. Cl. H04L 47/70; H04L 67/01; H04L 67/10

(52) U.S. Cl. CPC H04L 47/70; H04L 67/01; H04L 67/10

(57) ABSTRACT

A scalable multi-cluster resource sharing facility. A global witness process runs on a first computing platform that communicates over one or more networks to any number of nodes situated over two or more clusters. The global witness process listens on the network for occurrences of leadership and/or resource requests from nodes of different clusters. The global witness processes a request by retrieving a resource request and a respective last known state value, comparing the last known state value to a global stored state value, then storing a new state value when the respective last known state value is equal to the stored state value. Any number of contemporaneous requests can be processed by the global witness process, however only one request can be granted. The other requestors each receive a rejection of their resource request when their proffered last known state value is not equal to the stored state value.

### RELATED APPLICATIONS

The present application is a continuation of U.S. patent application Ser. No. 17/646,480 titled “SCALABLE LEADERSHIP ELECTION IN A MULTI-PROCESSING COMPUTING ENVIRONMENT”, filed on Dec. 29, 2021, which is a continuation of U.S. patent application Ser. No. 15/160,347 titled “SCALABLE LEADERSHIP ELECTION IN A MULTI-PROCESSING COMPUTING ENVIRONMENT”, filed on May 20, 2016, which is hereby incorporated by reference in its entirety.

### FIELD

This disclosure relates to architectures for high-availability multi-processing computing platforms, and more particularly to techniques for scalable leadership election using a global witness process in a multi-cluster computing environment.

### BACKGROUND

Some computing tasks are parallelized such that there is a master (or leader) and many slaves (or followers). Often, the software images that are executed by the instance of the leader and the instances of followers is the same image, and the determination as to whether a particular instance is to act as the leader or act as a follower is made on the basis of the existence and/or contents of a status file that is accessed by the image. Under such a scenario, it can happen that a group of instances are deployed (e.g., started up as individual processes or individual threads) and the determination as to which one member of the group becomes the leader is made by the first instance to “come up” and create and/or write a value into the aforementioned status file. The file system serves as a sequencer/arbiter as to which one process or thread from the group becomes the leader.

At some point after initial determination of the leader, the leader might “die” (e.g., the thread stops unexpectedly, or the process runs into a segmentation or other fault). This leaves the aforementioned file in a state that does not reflect the actual state (e.g., that there is no leader anymore). Additional functions need to be provided so as to “re-elect” a leader in the case that the former leader no longer has the capacity to serve in the leader's role. Some mechanisms have been attempted where all processes or threads periodically check for a “heartbeat” or other periodic liveness signal from the leader, and if such a heartbeat or other periodic liveness signal from the assigned leader is not detected, then the followers will vote among themselves to determine a majority and, in turn, a new leader. In some cases an independent witness task process that functions other than as a leader or other than as a slave can be deployed, and can thenceforth be consulted to break a tie so that a majority can be formed.

Unfortunately, there are some deployments that have a leader-follower relationship between just two actors (e.g., processes, threads, virtual machines, etc.). In such cases, a majority cannot be formed after loss of leadership—since there then remains only one process. For example, in a disaster recovery situation, there might be a block change monitor that detects and forwards changed storage blocks to a listening backup process at another location (e.g., located on another cluster in a geographically distal location). If a leader (e.g., the block change monitor) were to die or become unreachable, the remaining slave (e.g., the listening backup process) by itself cannot use the aforementioned legacy techniques to reestablish a new leader.

Worse, in a large computing environment, such as an environment having multiple clustered computing platforms, there might be multiple file systems in operation. Legacy approaches that rely on leadership determination based on the first to create (or write to) the aforementioned status file cannot be used to elect just one leader from among the group of instances.

Still worse, legacy approaches that involve a witness deploy witness processes on a one-to-one basis with respect to the deployed master/slave images. Managing witnesses that are deployed one-to-one with respect to clusters (e.g., many actively involved witness processes) presents a management task that does not scale as the number of clusters increases.

What is needed is a technique or techniques to improve over legacy and/or over other considered approaches. Specifically, what is needed is a technique that provides a single witness process for an arbitrarily large number of clusters. Moreover, what is needed is a way for a single witness process to perform the functions of a witness or arbiter that is resilient to temporary or permanent node or cluster outages. Some of the approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

The present disclosure provides a detailed description of techniques used in systems, methods, and in computer program products for scalable leadership election using a centralized witness process in a multi-processing computing environment, which techniques advance the relevant technologies to address technological issues with legacy approaches. More specifically, the present disclosure provides a detailed description of techniques used in systems, methods, and in computer program products for scalable leadership election using a centralized witness process in a multi-processing computing environment. Certain embodiments are directed to technological solutions for breaking a tie by using a centralized witness process that accesses a data structure under a compare-and-swap (CAS) access regime, which embodiments advance the relevant technical fields as well as advancing peripheral technical fields.

The disclosed embodiments modify and improve over legacy approaches. In particular, the herein-disclosed techniques provide technical solutions that address the technical problems attendant to in many modern computing deployments where a plurality of processes need to reach a consensus as to leader/follower relationships. Such technical solutions serve to reduce the demand for computer memory, reduce the demand for computer processing power, and reduce the demand for inter-component communication. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of high-performance computing as well as advances in various technical fields related to distributed storage systems.

Further details of aspects, objectives, and advantages of the technological embodiments are described herein and in the following descriptions, drawings, and claims.

### BRIEF DESCRIPTION OF THE DRAWINGS

The drawings described below are for illustration purposes only. The drawings are not intended to limit the scope of the present disclosure.

FIG. 1A1 and FIG. 1A2 depict distributed processing environments.

FIG. 1B1 and FIG. 1B2 depict uses of a global witness process in a distributed processing environment having a leader on one cluster and multiple followers on other clusters, according to some embodiments.

FIG. 1C depicts a remote office, branch office (ROBO) environment having a leader on one cluster and multiple followers on other clusters.

FIG. 2A presents a leadership determination flowchart to implement leadership election using a centralized witness process in a multi-processing computing environment, according to an embodiment.

FIG. 2B presents a liveness determination flowchart to implement leadership election using a centralized witness process in a multi-processing computing environment, according to an embodiment.

FIG. 3 depicts a relationship storage area as used to implement leadership election using a centralized witness process in a multi-processing computing environment, according to an embodiment.

FIG. 4 exemplifies a leadership offer serialization technique as used to implement leadership election using a centralized witness process in a multi-processing computing environment, according to some embodiments.

FIG. 5 exemplifies a global state table population technique, according to an embodiment.

FIG. 6A exemplifies a set of witness process operations as used to implement resource ownership using a centralized witness process in a multi-processing computing environment, according to some embodiments.

FIG. 6B exemplifies a set of witness process operations as used to implement leadership election using a centralized witness process in a multi-processing computing environment, according to some embodiments.

FIG. 7 exemplifies a compare-and-swap (CAS) flow as used to implement leadership election using a centralized witness process in a multi-processing computing environment, according to an embodiment.

FIG. 8 exemplifies a job field management technique for scalable leadership election using a centralized witness process in a multi-processing computing environment, according to an embodiment.

FIG. 9 depicts a system components as arrangements of computing modules that are interconnected so as to implement certain of the herein-disclosed embodiments.

FIG. 10A and FIG. 10B depict architectures comprising collections of interconnected components suitable for implementing embodiments of the present disclosure and/or for use in the herein-described environments.

### DETAILED DESCRIPTION

Some embodiments of the present disclosure address the problems exhibited in many modern computing deployments where a plurality of processes need to reach a consensus as to leader/follower relationships. Some embodiments are directed to approaches for breaking a tie by using a centralized witness process that accesses a data structure under a compare-and-swap (CAS) access regime. More particularly, disclosed herein and in the accompanying figures are exemplary environments, systems, methods, and computer program products for scalable leadership election using a centralized witness process in a multi-processing computing environment.

### Overview

In an a priori manner (e.g., before deployment of any processes to perform any jobs) a single witness process is started up at one node that is accessible by any process or thread that is/are expected to perform either as a leader or as a follower.

Deployments that have various processes spread out over multiple clusters (e.g., over wide geographic areas) are often interconnected (e.g., over a cloud backbone, or over the internet) such that the various processes make continuous progress in synchronicity, where an agent/leader process or thread sends data to one or more listener/follower processes or threads. If it happens that an agent fails or ceases to communicate with the one or more listener/follower, then the synchronized progress stops and a new agent/leader is needed. In leader-follower scenarios, if it happens that a leader fails or ceases to communicate with the one or more followers, then the synchronized progress stops and a new leader is needed. In some deployments (e.g., clustered deployments) the nodes need to form a majority to form a consensus. An alternative method which is disclosed herein is to organize around an arbitrator, which arbitrator can pick a node to become the leader. A global witness service serves to bring the deployment back into service (e.g., with a newly elected leader and with all followers in agreement with the newly elected leader).

As can be understood, techniques that rely on multiple process access to a disk-based (e.g., SCSI) operation semaphore are only applicable when all of the processes to perform any jobs are in the same disk access group (e.g., in the same processor group, or cluster). Furthermore, legacy techniques that rely on a witness process to break a tie between a leader and follower are only applicable when all of the processes to perform any jobs are in cluster.

What is described herein is a global witness service. The figures provide successive disclosure of the concepts involved, including functions of a global witness service and including a range of implementation options. Strictly as an overview, the global witness service concept relies in part on a global witness process that provides leadership determination among a set of nodes. The global witness service uses a database that provides compare-and-swap properties. Each node in a deployment that offers to become a leader (e.g., upon detection or determination that the services of a leader has been lost) uses the same application programming interface to query the service, and the herein-disclosed global witness service will pick exactly one of the offerors in the cluster to become a leader. A database access method and data structure is disclosed. The service operates in conjunction with the data structure. For example the service, upon receiving a leadership offer from a node, will attempt to write a particularly-formed key/value pair using a compare-and-swap operation. If the particular compare-and-swap operation (e.g., using the particularly-formed key/value pair) succeeds, then the offeror becomes the leader. Otherwise, the global witness service deems that a leader has already been selected, and the offeror is so advised.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment. An aspect or an advantage described in conjunction with a particular embodiment is not necessarily limited to that embodiment and can be practiced in any other embodiments even if not so illustrated. Also, references throughout this specification to “some embodiments” or “other embodiments” refers to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments.

### Definitions

Some of the terms used in this description are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### Descriptions of Exemplary Embodiments

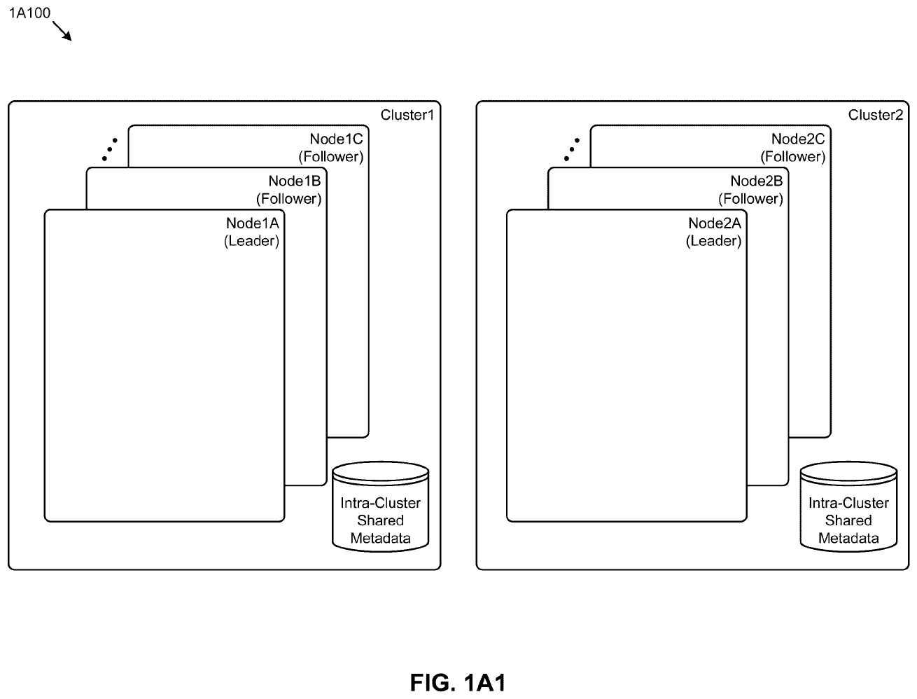

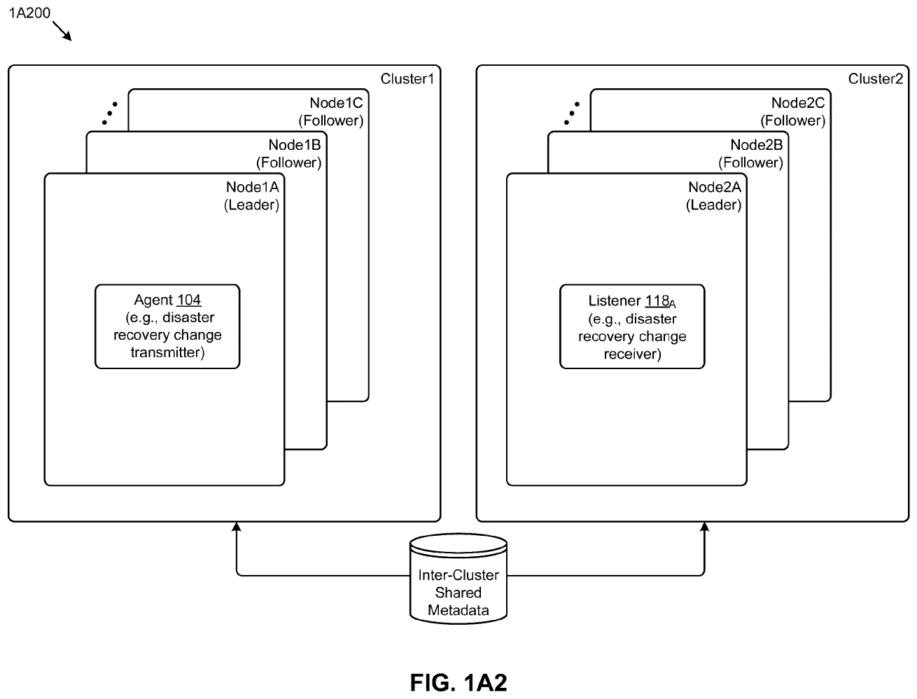

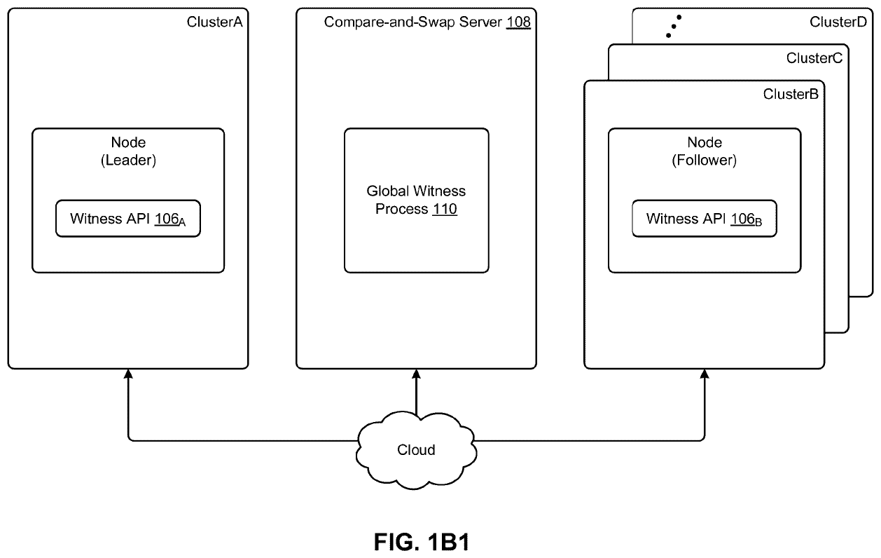

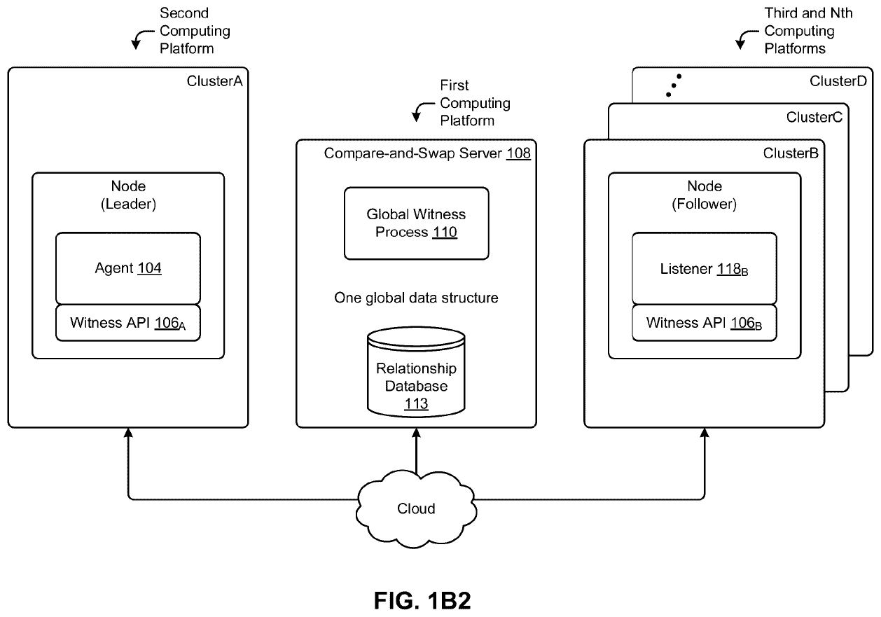

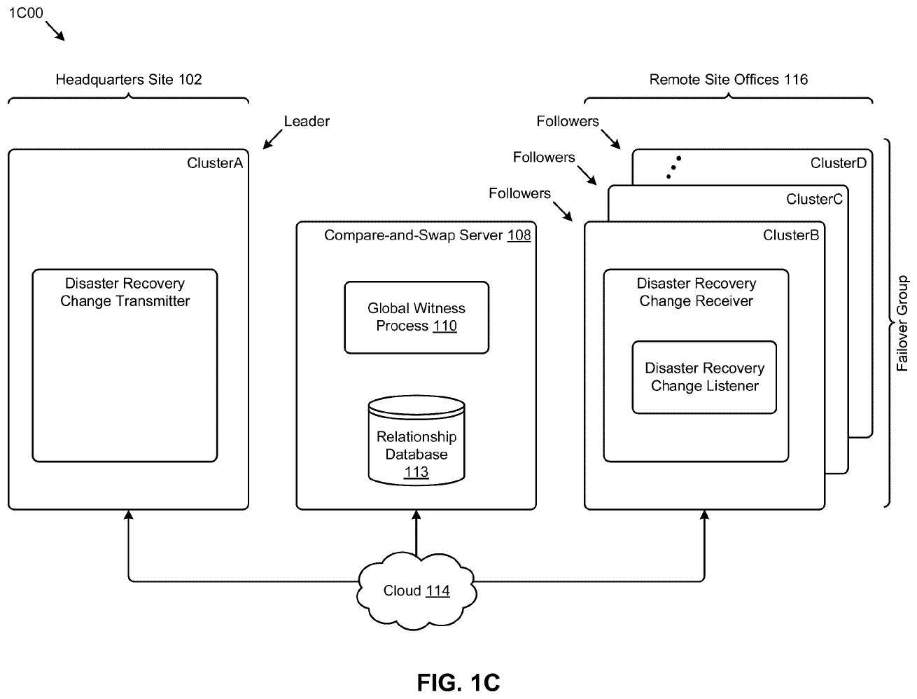

FIG. 1A1 depicts an environment 1A100 having multiple clusters, each cluster having a respective leader and multiple followers. Each cluster accesses intra-cluster shared metadata that is shared between nodes within the cluster. Intra-cluster shared metadata can be used to organize leader-follower activities within a cluster, but the intra-cluster data cannot be relied upon to organize leader-follower activities between the clusters. Inter-cluster shared data can be stored and accessed so as to facilitate organization of leader-follower activities between clusters. One example is given in the following FIG. 1A2.

FIG. 1A2 depicts an environment 1A200 having multiple clusters, with each cluster having a respective leader and multiple followers. A leader process on one platform communicates over a network to one or more follower processes on any cluster. In some situations the leader process (e.g., agent 104) is configured so as to detect system changes (e.g., storage operations, block changes, configuration changes, etc.) and to communicate a copy of those changes to a listener 118A process in a different cluster, such as might be located in a geographically distant location accessible over a network.

The shown inter-cluster shared metadata is used by the agent and listeners to organize their relationships to each other (e.g., leader or follower). Leadership determination and follower determination can be used in a variety of multiple cluster scenarios. For example, in a disaster recovery scenario, the leader process in a first cluster is configured to detect and/or receive storage block changes (e.g., see agent 104) and to communicate copies of those storage block changes to one or more different clusters that run follower tasks (e.g., see listener 118A).

Architectures that involve deployment of a leader process on one cluster and one or more follower processes on a different cluster sometimes precipitate an unwanted task interaction scenario termed “split brain”. Often, split-brain scenarios exhibit unwanted interactions, especially when sharing data. In scenarios that rely on uninterrupted availability of a leader task, even in high-availability scenarios, intended uninterrupted availability of a leader task can be interrupted (e.g., due to failure of a node or network or due to a cluster-wide outage or cluster-wide disaster). A witness process serves to avoid split-brain conflicts that can precipitate shared data corruption. A witness process resides in a failure domain that is separate from the leader process failure domain.

FIG. 1B1 and FIG. 1B2 depict uses of a global witness process in a distributed processing environment having a leader on one cluster and multiple followers on other clusters. As an option, one or more variations of distributed processing environment or any aspect thereof may be implemented in the context of the architecture and functionality of the embodiments described herein. In addition, the distributed processing environment or any aspect thereof may be implemented in any environment.

The embodiment shown in FIG. 1B1 is merely one example. As shown, a leader node (e.g., see the node of clusterA) interfaces to an application programming interface (e.g., witness API 106A). In addition, a follower node (e.g., see the node of clusterC) is interfaced to an application programming interface (e.g., witness API 106B). A global witness process 110 runs in a compare-and-swap server 108. The embodiment of FIG. 1B1 is merely an illustrative embodiment where the leader, any number of followers and the compare-and-swap server are each in separate failure domains, however, the global witness process 110 in the compare-and-swap server 108 can run on any node in any cluster.

The embodiment shown in FIG. 1B2 depicts, a receiver-transmitter embodiment of an agent 104 that is interfaced to an application programming interface (e.g., witness API 106A). In addition, a listener 118B is interfaced to an application programming interface (e.g., witness API 106B). Additional clusters (e.g., cluster, clusterD, etc.) can each support nodes with additional listeners.

In certain deployments, a particular process image (e.g., binary image) is constructed (e.g., by a developer) such that the functions of a transmitter (e.g., a block change transmitter agent) as well as the functions of a receiver (e.g., a disaster recovery change listener) are included in the same image. The particular parameters that pertain to the setting (e.g., in a branch deployment or in a remote office deployment) and/or the particular parameters that pertain to respective roles of leader or follower are determined at run-time based, for example, on conditions and/or parameter that are present and/or determined at the time of invocation. A particular process image can be deployed as a task or process or thread, or a virtual machine (VM) or as a container. Further, the topology of nodes or clusters as interconnected by a network can include spoke-and-wheel topologies, mesh topologies, ring topologies, etc.

Certain aspects in some embodiments of the present application are related to material disclosed in U.S. patent application Ser. No. 14/144,520, issued as U.S. Pat. No. 9,286,344 titled, “METHOD AND SYSTEM FOR MAINTAINING CONSISTENCY FOR I/O OPERATIONS ON METADATA DISTRIBUTED AMONGST NODES IN A RING STRUCTURE” (Attorney Docket No. Nutanix-013) filed on Dec. 30, 2013 the content of which is incorporated by reference in its entirety in this application.

As heretofore discussed, a particular process image (e.g., binary image) is constructed (e.g., by a developer) such that the functions of a transmitter as well as the functions of a receiver are included in the same image. One method for run-time determination of a role (e.g., transmitter or receiver) and relationship (e.g., leader or follower) and is given infra.

The elected leader and any number of followers process continuously, until such time as a leader process is deemed to have crashed or is otherwise unreachable. As earlier described, any of the aforementioned processes can access a global witness process 110 that consults a relationship database 113. Such a relationship database consultation can be performed on a compare-and-swap server 108 that resides in a failure domain separate from the shown clusterA. A relationship database stores one or more state values, which can be used to determine and/or establish a relationship (e.g., leader, follower, owner, etc.) of a process.

Any of a variety of information that is passed to and from the global witness process can be stored in a relationship storage area. One possible organization of computing infrastructure includes a relationship storage area and logic needed for leadership election using a centralized witness process in a multi-processing computing environment, such as in a remote office, branch office environment (ROBO) scenario.

FIG. 1C depicts a remote office, branch office environment having a leader on one cluster (e.g., at a headquarters site 102) and multiple followers on other cluster (e.g., in remote sites offices 116). As an option, one or more variations of ROBO environment 1C00 or any aspect thereof may be implemented in the context of the architecture and functionality of the embodiments described herein. In addition, the ROBO environment 1C00 or any aspect thereof may be implemented in any environment.

The embodiment shown in FIG. 1C is merely one example. As shown, a computing platform (e.g., the shown clusterA) serves as a headquarters site deployment. Computing resources for one or more remote offices are deployed on additional clusters (e.g., clusterB, clusterC, and clusterD). Communication between the headquarters site 102 (e.g., that hosts a leader process) to any of the remote site offices 116 (e.g., see clusterB, clusterC, and clusterD) is facilitated by network services provided in or by the shown cloud 114.

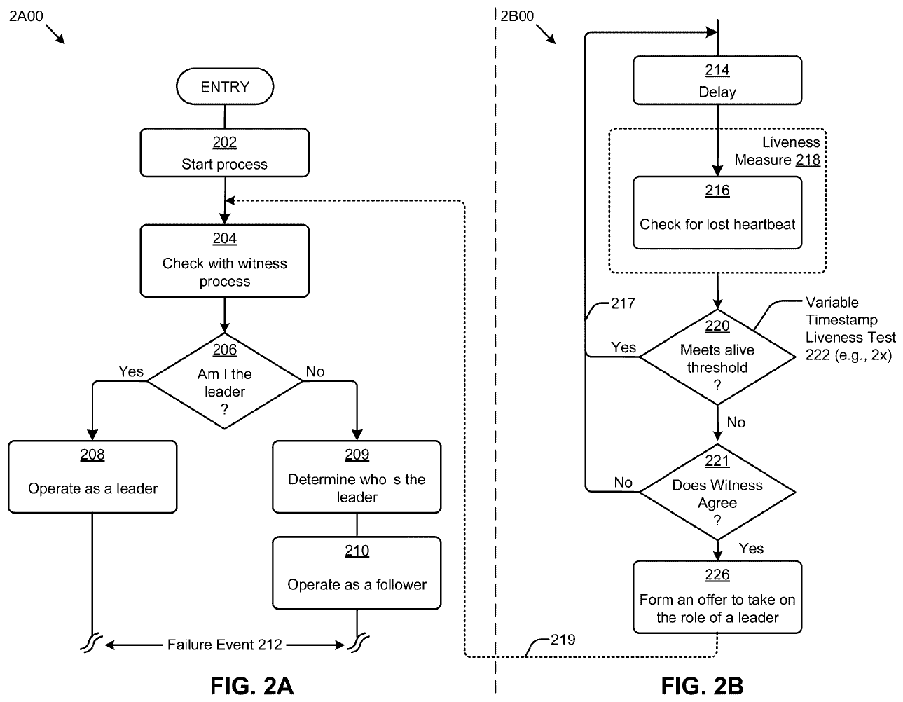

When a leader process is deemed to have crashed (see FIG. 2B) or is otherwise unreachable, any of the aforementioned processes can access a global witness process that resides in a failure domain separate from the ROBO failure group. Continuing this example, such a global witness process can be implemented on a separate server (e.g., compare-and-swap server 108) that resides in a failure domain separate from the ROBO failure group. Such a separate server can host a global witness process 110. In a disaster recovery scenario, a primary process (e.g., disaster recovery change transmitter) might be teamed-up with other processes that are configured as s disaster recovery change receivers. Any of the aforementioned processes from any cluster can offer to become a leader should the formerly designated leader process be deemed to have crashed. In some cases, computing infrastructure at the headquarters site includes multiple nodes, any of which can host a leader process should it be so elected after consulting with the global witness process.

Several approaches to implement hosting a global witness process 110 are considered herein. In one approach, the global witness process is configured as an “active witness”. Such an active witness periodically pings all the sites (e.g., clusters) in a deployment and stores the health information. In another approach the witness and/or ancillary or constituent data structures are updated by the participating sites based on a predetermined compare and swap (CAS) protocol.

This latter approach includes the notion of a local witness function in addition to the aforementioned global witness process. Specifically, a local witness function is implemented as a one-per-site entity that communicates with a global witness process. The local witness functions to pass information to and from the global witness process. A local witness process can be implemented as a standalone process, and/or can be implemented as a thread, and/or can be implemented using an application programming interface.

Certain aspects in some embodiments of the present application are related to material disclosed in U.S. patent application Ser. No. 14/610,285 titled, “PULSED LEADER CONSENSUS MANAGEMENT” (Attorney Docket No. Nutanix-039) filed on Jan. 30, 2015, the content of which is incorporated by reference in its entirety in this application.

Various logic can be implemented in a central location, or can be distributed. The following FIG. 2A presents merely one partitioning possibility for logic flows used to implement leadership election.

FIG. 2A presents a leadership determination flowchart 2A00 to implement leadership election using a centralized witness process in a multi-processing computing environment. As an option, one or more variations of leadership determination flowchart 2A00 or any aspect thereof may be implemented in the context of the architecture and functionality of the embodiments described herein. In addition, the leadership determination flowchart 2A00 or any aspect thereof may be implemented in any environment.

The flow shown in FIG. 2A commences contemporaneously with the start-up invocation of a leader/follower image (see step 202). The process (or thread) checks with the global witness process (see step 204) and receives a response from the global witness process. As shown, decision 206 has two branches based on a test “AM I THE LEADER”. A “YES” result causes the image to take on the role of a leader (see step 208). A “NO” result causes the image to determine who is the leader (see step 209), and to take on the role of a follower (see step 210). In this and certain other embodiments, once the determination of leader/follower has been made, that role is the role assumed persistently until the process detects some occurrence that indicates the global witness process is to be again consulted. Such an occurrence can be a failure event 212, or can be as a result of a liveness measure. During processing of the flow of FIG. 2A, up to and including the “NO” branch of decision 206, the global witness process will return an indication of which process is the leader process.

FIG. 2B presents a liveness determination flowchart 2B00 to implement leadership election using a centralized witness process in a multi-processing computing environment. As an option, one or more variations of liveness determination flowchart 2B00 or any aspect thereof may be implemented in the context of the architecture and functionality of the embodiments described herein. In addition, the liveness determination flowchart 2B00 or any aspect thereof may be implemented in any environment.

Liveness determination operates as follows:
The leader sends out a periodic liveness signal to be received by all followers.
The followers check periodically for liveness of the leader. A check, such as for a heartbeat, is executed (see step 216) and the result(s) of the check are compared against some liveness measure 218. A liveness measure check can refer to a constant time period check since the last detected heartbeat that was sent by the then-current leader. Or a liveness measure can include a check against a variable time period check (e.g., see variable timestamp liveness test 222), where variation in the duration of the time period check can be dependent on various conditions such as geographic location, system load, local node time (e.g., 12 PM CST), remote node time (e.g., 9 AM GMT), and/or other measurements.
Determine if the value of the liveness measure is within a predetermined or calculated bound and/or if the value of the liveness measure check meets a threshold test (see decision 220).
When the “YES” branch is taken, the witness is consulted to check (see decision 221) if the witness agrees that the leader is dead. If not, the loop 217 is taken (e.g., to check again later).
When the “NO” branch of decision 221 is taken, the subject process (e.g., the leader process that was checked in step 216) is deemed to be alive, and a check for liveness is performed again (see loop 217) after a delay (see step 214).
When the “YES” branch of decision 221 is taken, the leader is deemed to be dead or otherwise incapable of performing the role of the leader. Moreover, when the
“YES” branch of decision 221 is taken, next steps serve to initiate formation of an offer to take on the role of a leader (see step 226). The global witness process is presented (see path 219) with the offer.

By following all or parts of the flow, multiple nodes in various computing clusters that are connected over a network to the global witness process can determine if a resource owner is alive. In exemplary embodiments, resources are exposed so as to be accessed by the multiple nodes. A first node contacts the global witness process to establish ownership the resource. A second node of the multiple nodes may deem that the it is unable to contact the first node, and may then seek a witness determination that the first node is indeed down (e.g., by contacting the global witness process to get a second opinion that that the first node is not operational). The others of the multiple nodes may also contact the global witness process (e.g., to get a second opinion that that the first node is not operational). One of the multiple nodes will be successful in establishing new ownership of the resource (e.g., since the former owner cannot be contacted and is deemed to be down). The others of the multiple nodes will not be successful in establishing new ownership, so there will be only one owner. A resource can be a role, such as a leadership role. In such situations, one of the multiple nodes will be successful in establishing a new leadership role (e.g., since the former owner cannot be contacted and is deemed to be down). The others of the multiple nodes will not be successful in establishing new leadership role, and may take on the role of a follower.

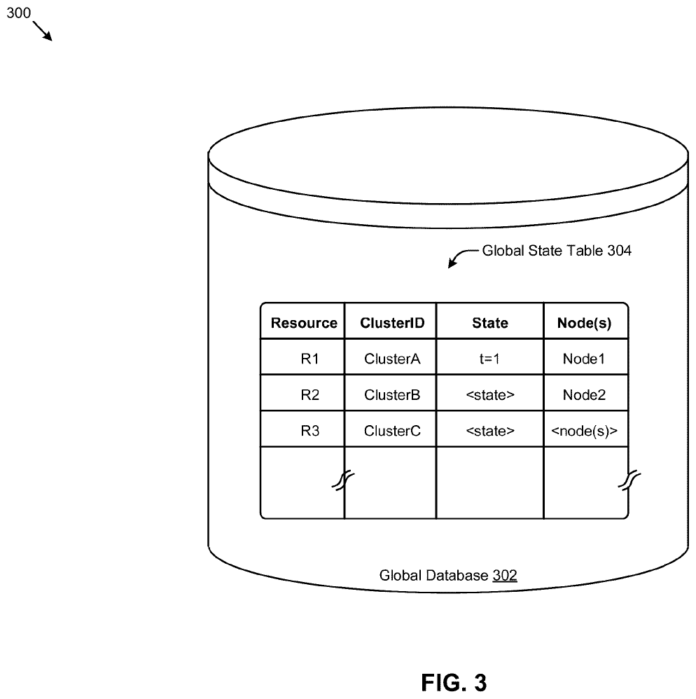

A relationship storage area is maintained such that a leader assignment can be determined, and can be reassigned (e.g., to a replacement leader) by any process in the ecosystem. A leadership role can be established at any level of granularity over any entity or resource. For example, a leader can be established to oversee a particular job running on a particular VM on a particular node in a particular cluster. Entities and relationships thereto can be stored in a relationship storage area (e.g., a widely-accessible relationship storage area). One example of a relationship storage area is given in FIG. 3.

FIG. 3 depicts a relationship storage area 300 as used to implement leadership election using a centralized witness process in a multi-processing computing environment. As an option, one or more variations of relationship storage area 300 or any aspect thereof may be implemented in the context of the architecture and functionality of the embodiments described herein. In addition, the relationship storage area 300 or any aspect thereof may be implemented in any environment.

The embodiment shown in FIG. 3 is merely one example. The relationship storage area 300 can take the form of a global file and/or a memory structure (e.g., a cache of a global file) and/or can take the form of a global database 302, which in turn may comprise a global state table 304.

A global state table can comprise columns having entries for any domain or granularity. As shown, a global state table 304 might include domains at a relatively low levels of granularity (e.g., at the level of resources) and/or can include domains at relatively higher levels of granularity (e.g., cluster level). Such a table can have columns having additional entries for identification (e.g., entries for a set of nodes). One column in each row holds a state value. The state value is managed by the aforementioned compare-and-swap operations.

The clusterID can take the form of a unique identifier to refer to a respective cluster. The set of nodes can be a list of one or more identifiers to refer to a processing entity in a cluster. The identifier referring to a processing entity need not be unique, so long as the combination of the clusterID and any identifier referring to a processing entity is a unique combination. The state value can be a monotonically increasing number (e.g., a logical timestamp). The state value can be initialized to some initial value that is different from any of the monotonically increasing numbers that might be stored in this column.

Following this embodiment, an update to the relationship storage area succeeds in the case of a TRUE condition for any the following tests:
There is no entry already stored for the {clusterID, processing entity ID} combination.
The stored state value for the accessed row (e.g., with row access key={clusterID, processing entity ID}) has a value that is lesser than a newly passed-in state value.
The stored entry is completely identical to the newly passed-in entry.

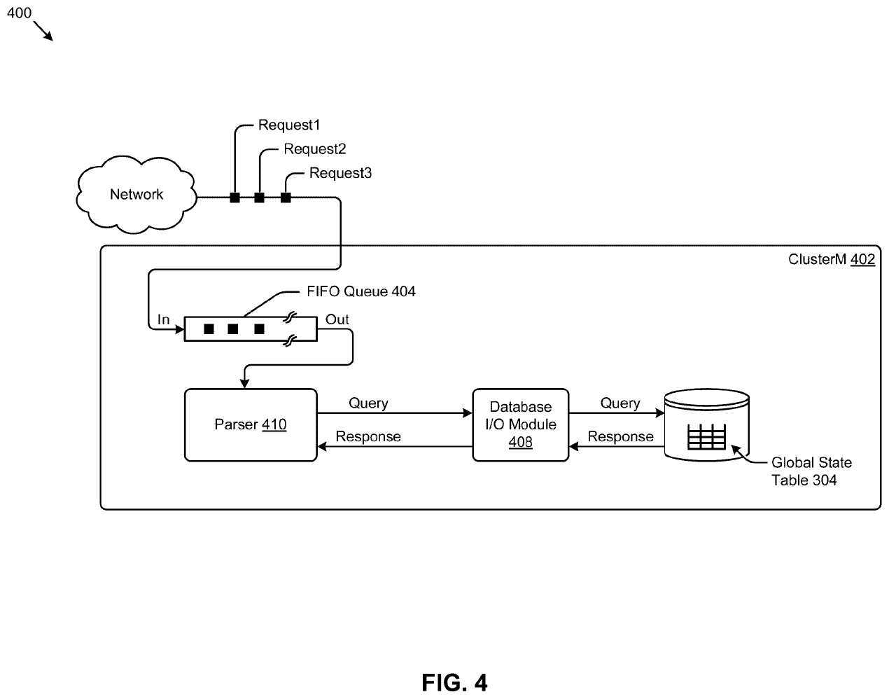

The global witness service is granted exclusive write access to the relationship database. Any one or more processes running on any one or more clusters can send a request (e.g., an offer to assume leadership) to the global witness service. Leadership offers and any other sorts of commands or requests are serialized, such as is shown in FIG. 4.

FIG. 4 exemplifies a leadership offer serialization technique 400 as used to implement leadership election using a centralized witness process in a multi-processing computing environment. As an option, one or more variations of leadership offer serialization technique 400 or any aspect thereof may be implemented in the context of the architecture and functionality of the embodiments described herein. In addition, the leadership offer serialization technique 400 or any aspect thereof may be implemented in any environment.

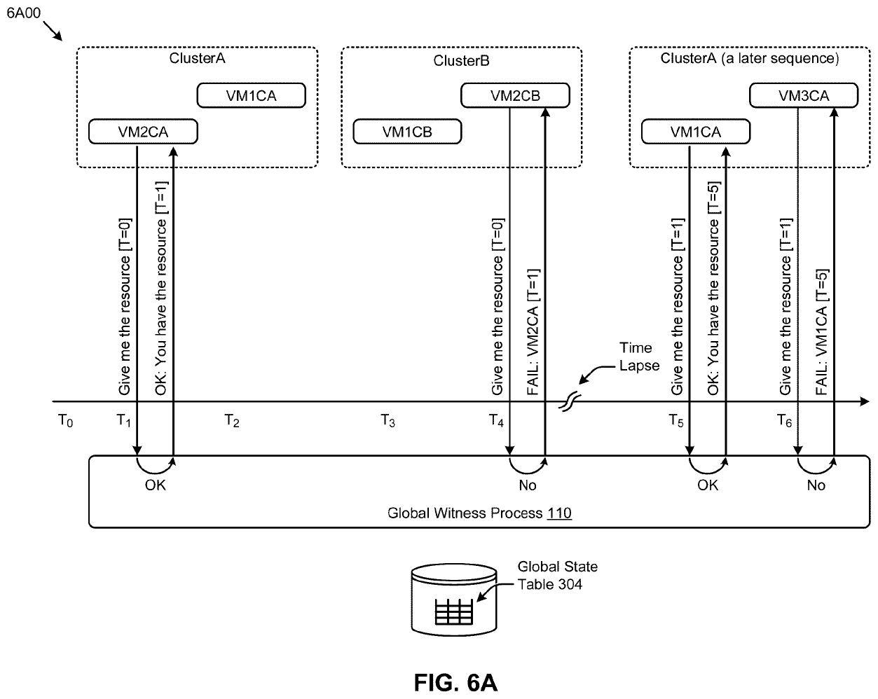

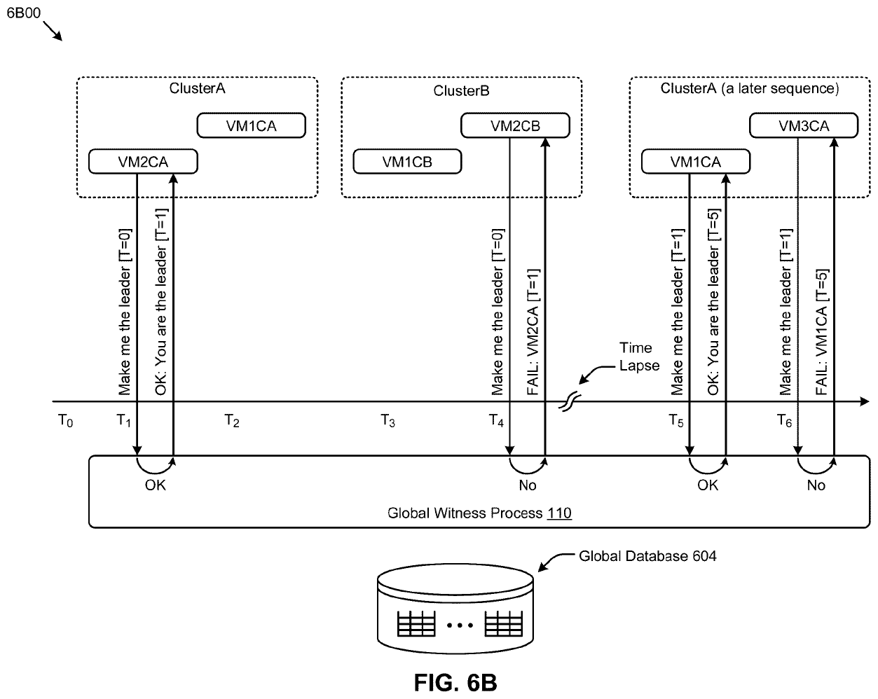

The shown clusterM 402 is a cluster that defines, or is in a failure domain separate from, the leader process failure domain. ClusterM receives leadership offers and any other sorts of commands or requests (e.g., requests1, request2, request3, etc.) over a network. The requests are queued into a first-in-first-out (FIFO) facility (e.g., FIFO queue 404) before being passed to a database operation processor (e.g., database I/O module 408). A request is taken out of the queue and the request is parsed (see parser 410). A database query or other sort of access to the relationship storage area is made, possibly using a database I/O (input/output or IO) module. In this embodiment, the global state table 304 is accessed and, in some cases, a state value is changed. Examples of situations where a state value is changed are given in FIG. 6A and FIG. 6B.

Serialization can be performed over any received request, regardless of origin and/or regardless of the nature of the request. In some cases, a request is made as pertaining to a particular job that is being performed in a particular cluster.

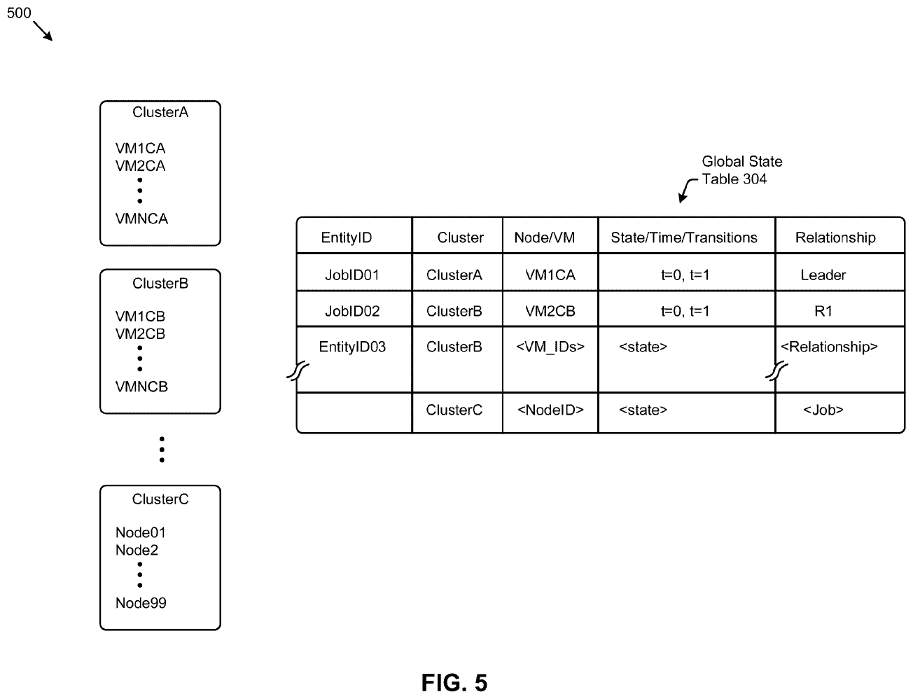

FIG. 5 exemplifies a global state table population technique 500 as used to define a failover set of processes. As an option, one or more variations of a global state table population technique 500 or any aspect thereof may be implemented in the context of the architecture and functionality of the embodiments described herein. In addition, a global state table population technique 500 or any aspect thereof may be implemented in any environment.

A global state table can comprise rows that correspond to entities under management. The entities can refer to a particular object (e.g., a file) or a process (e.g., a job or function such a backup or recovery jobs), or a relationship (e.g., leader). The global state table can be initially populated and then managed on an ongoing basis so as to maintain integrity of ownership of a particular entity or leadership among a group of contenders. As shown, a global state table can include data (e.g., columns) that track states and state transitions pertaining to ownership or leadership. In some cases, a time indication can be used as one of several state variables. Any number of tasks or processes or threads can run concurrently and can access the global state table. The global state table can be used in conjunction with a global witness so as to reassign ownership of an entity and/or to re-assign (e.g., re-elect) a leadership relationship.

As earlier indicated, a particular process image can be deployed as a task or process or thread, or a virtual machine (VM) or as a container. FIG. 5 depicts the scenario where several clusters (e.g., clusterA, clusterB, and clusterC) each serve as a host for a plurality of virtual machines (e.g., VM1CA, VM2CA, . . . VMNCA; VM1CB, VM2CB, . . . VMNCB; VM1CC, VM2CC, . . . VMNCC, etc.). Any one from among any group of VMs and/or containers can become a leader. As earlier described, the same process image can be used for both leaders and followers. Further, the same process image can be used for two or more processes that are assigned into a failover set. In such a case, the particular parameters that pertain to the determination of a primary leader role or a standby leader role can be determined at run-time based, for example, on conditions and/or parameter that are present and/or determined at the time of invocation.

As shown in FIG. 5, VM1CA and VM2CA are assigned into a failover set and are invoked (e.g., with primary/standby leadership conditions and/or parameters being present and/or determined at the time of invocation). In this example, both VM1CA and VM2CA are assigned to job=“J1”. At time t=0, each of the processes VM1CA and VM2CA communicates (e.g., with an ownership request or leadership offer) to the global witness process. The global witness process in turn makes an initial entry into the global state table 304. In this example, the virtual machine VM2CA happens to issue the leadership offer that is processed first. Accordingly, VM2CA's entry (as shown) indicates establishment of leadership at time t=1.

As earlier indicated, each node in a deployment that offers to become a leader uses the same application programming interface to query the service. The herein-disclosed global witness service will pick exactly one of the offerors in the cluster to become a leader. In this example, the virtual machine VM2CA takes on the leader role (see entry “t=1”) for processing job=“J1”.

### Loss of Leader

It can happen that a failure event occurs (see FIG. 2A), and upon such an event or shortly thereafter other processes detect the loss of a heartbeat, and deem that as a loss of a leader. Operations that depict actions taken for accessing a shared resource or for determining a new leader after losing a leader are presented in FIG. 6A and FIG. 6B.

FIG. 6A exemplifies a set of witness process operations 6A00 as used to implement resource ownership using a centralized witness process in a multi-processing computing environment. As an option, one or more variations of witness process operations 6A00 or any aspect thereof may be implemented in the context of the architecture and functionality of the embodiments described herein. In addition, the witness process operations 6A00 or any aspect thereof may be implemented in any environment.

The embodiment shown in FIG. 6A depicts interactions between several virtual machines distributed across several clusters. The serialization or requests, combined with the CAS properties being enforced over operations, results in establishment of exactly one resource owner at a time.

Referring to the timeline of FIG. 6A, the shown interactions occur during the timeframe t=1 through t=6. At time t=1 and time t=4, both of the virtual machines VM2CA and VM2CB make a request for access to a particular resource. It can happen that the request originating from virtual machine VM2CA is processed first (see “Give me the resource [T=0]” at time T₁) by the global witness process. The global witness process responds with an affirmative acknowledgement (e.g., see “OK: You have the resource [T=1]” at time T₁). Note that the acknowledgement response includes a monotonically increasing number. In this example, the monotonically increasing number is a logical timestamp. VM2CA's request is accepted and recorded, and VM2CA processes the acknowledgement response to save the logical timestamp as returned by the global witness process. Contemporaneously, the virtual machine VM2CB has issued an ownership request, however VM2CA's request was processed first. The global witness process returns a negative acknowledgement to VM2CB (e.g., see “FAIL: VM2CA [T=1]”).

As can be understood from the foregoing, virtual machines, including virtual machines that are running in different clusters that issue the later-processed resource ownership requests, all receive negative acknowledgements along with identification of the owner and the logical timestamp as of the “OK” acknowledgement that was sent to the owning process. This regime works as well even when the two or more requestors over a particular resource are running in the same cluster (e.g., see the example shown at T₅ and T₆).

FIG. 6B exemplifies a set of witness process operations 6B00 as used to implement leadership election using a centralized witness process in a multi-processing computing environment. As an option, one or more variations of witness process operations 6B00 or any aspect thereof may be implemented in the context of the architecture and functionality of the embodiments described herein. In addition, the witness process operations 6B00 or any aspect thereof may be implemented in any environment.

The embodiment shown in FIG. 6B depicts interactions between several virtual machines distributed across several clusters. The serialization or requests, combined with the CAS properties being enforced over operations, results in establishment of exactly one leader at a time.

Referring to the timeline of FIG. 6B, the shown interactions occur during the timeframe t=1 through t=6. At time t=1, both of the virtual machines VM2CA and VM2CB make an offer to lead. It happens that the offer originating from virtual machine VM2CA is processed first by the global witness process (see “Make me the leader [T=0]” at time T₁). The global witness process responds with an affirmative acknowledgement (e.g., see “OK: You are the leader [T=1]” at time T₁). Note that the acknowledgement response includes a monotonically increasing number; in this example, the monotonically increasing number is a logical timestamp. VM2CA's leadership request is accepted and recorded, and VM2CA processes the acknowledgement response to save the logical timestamp as returned by the global witness process. Contemporaneously, the virtual machine VM2CB has issued an offer to lead, however VM2CA's offer to lead was processed and granted first. The global witness process returns a negative acknowledgement to VM2CB (e.g., see “FAIL: VM2CA [T=1]”). As can be understood from the foregoing, the virtual machines corresponding to the later-processed leadership offers all received negative acknowledgements, along with identification of the leader and the logical timestamp of the leadership grant.

The foregoing is an example of operation of the global witness service. Specifically, upon receiving a leadership offer from a node, global witness service will attempt to write a particularly-formed key/value pair using a compare-and-swap operation. If the particular compare-and-swap operation (e.g., using the particularly-formed key/value pair) succeeds, then the offeror becomes the leader. Otherwise, the global witness service deems that a leader has already been selected, and the offeror is so advised. In the example of FIG. 6B, the particularly-formed key/value pair is formed from the combination of the clusterID (e.g., “clusterA”) and the virtual machine identification (e.g., “VM2CA”). Using this particularly-formed key/value pair, a single leader can be accepted for each cluster. A different cluster might host other processes, threads or VMs that contend for leadership when forming leader/follower relationships. A global database 604 comprising one or more state tables to hold a plurality of state values can be used to manage exclusivity to resources and/or exclusive leadership based on any one or more of the state values. In some cases, a global database 604 comprising a plurality of state values can be sharded to multiple storage locations. The sharding distribution can be based on the nature or characteristics of a state.

Merely as additional examples:
The VMs in the shown “clusterB” (see VM1CB and VM2CB) contend between themselves for leadership. VM1CB's offer is processed before VM2CB's offer, and accordingly VM1CB becomes the leader in clusterB.
At a later time, various events occur (see time lapse), which events may include loss of leadership (e.g., crash) of the formerly-assigned leader VM2CA. Should this occur, VM1CA would recognize the loss of a heartbeat to VM2CA. VM1CA (as well as other VMs that recognize the loss of a heartbeat to VM2CA would contend for leadership. As shown in the later sequence for clusterA beginning at time T₅, VM1CA becomes the leader, and all other VMs that contend for leadership would receive a negative acknowledgement. All of the other VMs that contend for leadership would receive an indication of the elected leader VM1CA and the logical timestamp of the time upon which the elected leader VM1CA became the leader.

Note that at this point in the timeline, even if the formerly-assigned leader VM2CA that was deemed to be “crashed” was restarted, it would receive a negative acknowledgement from the global witness process 110, since VM1CA had requested and received leadership.

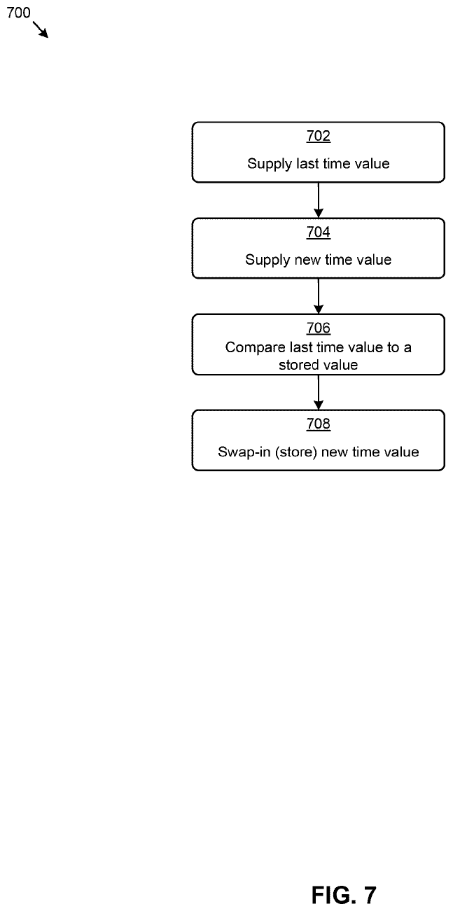

FIG. 7 exemplifies a compare-and-swap (CAS) flow 700 as used to implement leadership election using a centralized witness process in a multi-processing computing environment. As an option, one or more variations of CAS flow 700 or any aspect thereof may be implemented in the context of the architecture and functionality of the embodiments described herein. In addition, the CAS flow 700 or any aspect thereof may be implemented in any environment.

In this embodiment, a centralized witness process processes in accordance with the CAS flow 700. Specifically, the centralized witness process receives a “last time value” (e.g., “[T=1]”) taken from a leadership offer (see step 702). The centralized witness process checks the current time and forms a logical timestamp (see step 704). The last time value is compared (e.g., see step 706) to a stored value (e.g., the stored value in the global state table) to determine if the offer is to be accepted (e.g., with a positive acknowledgement) or denied (e.g., with a FAIL negative acknowledgement). In cases when the offer is accepted, then the new time value is swapped-in to the stored location (see step 708). In some situations, techniques other than compare-and-swap can be used to police consistency pertaining to rights and/or accesses, and/or to facilitate leadership election. For example, locks or semaphores can be used.

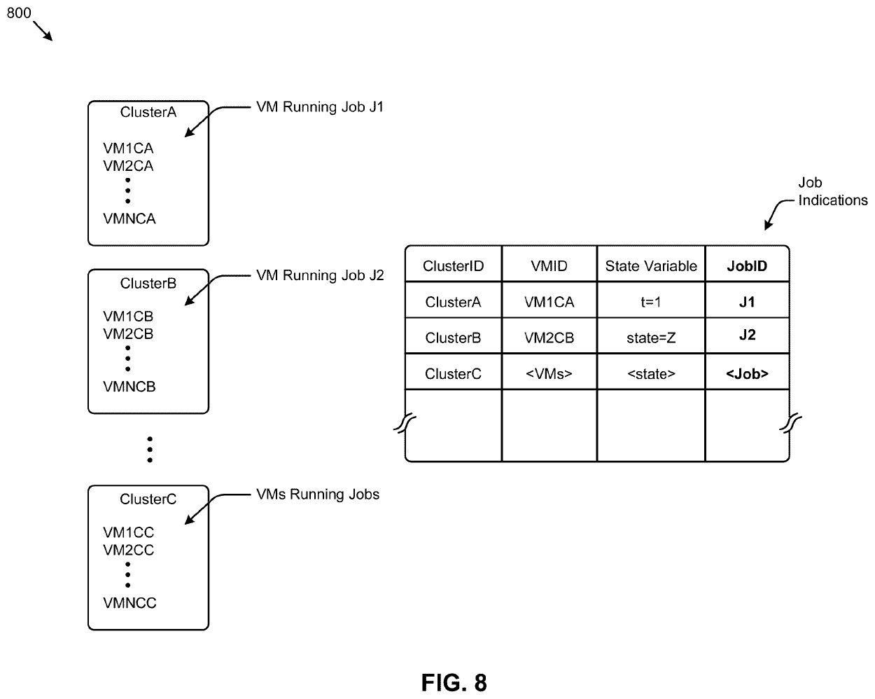

FIG. 8 exemplifies a job field management technique 800 for scalable leadership election using a centralized witness process in a multi-processing computing environment. As an option, one or more variations of job field management technique 800 or any aspect thereof may be implemented in the context of the architecture and functionality of the embodiments described herein. In addition, the job field management technique 800 or any aspect thereof may be implemented in any environment.

The embodiment shown in FIG. 8 is merely one example of using a global state table that can be used in a key lookup and other job field management operations. In this case, the job column includes a job indication “J1” for VM1CA and includes a job indication “J2” for VM2CB. A job ID is merely one example of using a particularly-formed key/value pair. A single leader or owner can be accepted for the domain referred to by the key. For example, the domain can be formed from just the cluster identification (e.g., to provide just one leader per clusterID, irrespective of a job assignment), or can be formed from just the job indication (e.g., to provide just one leader per job, irrespective of the cluster assignment). Any state variable can be used in conjunction with any particularly-formed key/value pair in any domain.

### Additional Embodiments of the Disclosure

### Additional Practical Application Examples

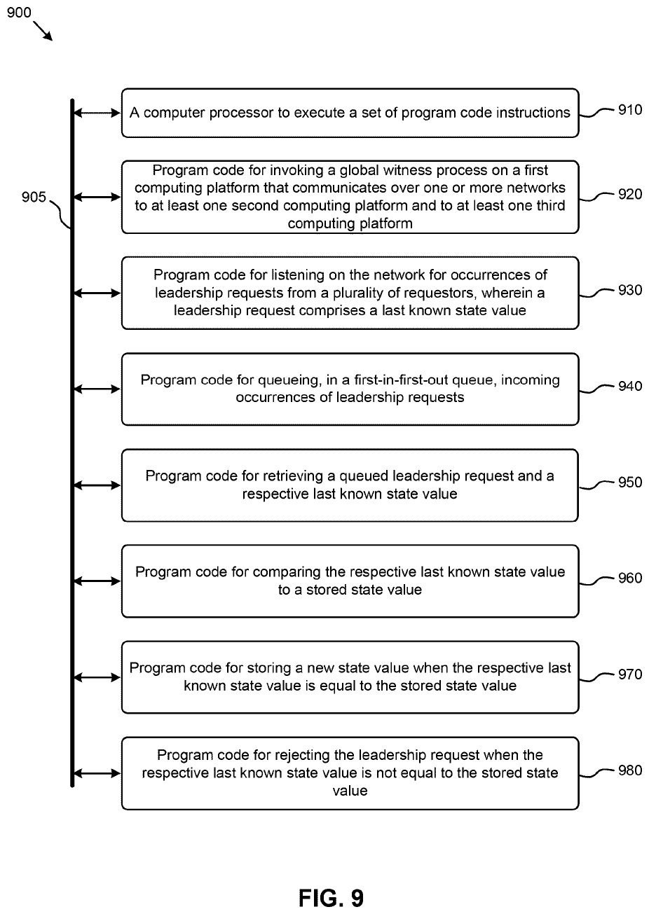

FIG. 9 depicts a system 900 as an arrangement of computing modules that are interconnected so as to operate cooperatively to implement certain of the herein-disclosed embodiments. The partitioning of system 900 is merely illustrative and other partitions are possible. As an option, the system 900 may be implemented in the context of the architecture and functionality of the embodiments described herein. Of course, however, the system 900 or any operation therein may be carried out in any desired environment.

The system 900 comprises at least one processor and at least one memory, the memory serving to store program instructions corresponding to the operations of the system. As shown, an operation can be implemented in whole or in part using program instructions accessible by a module. The modules are connected to a communication path 905, and any operation can communicate with other operations over communication path 905. The modules of the system can, individually or in combination, perform method operations within system 900. Any operations performed within system 900 may be performed in any order unless as may be specified in the claims.

The shown embodiment implements a portion of a computer system, presented as system 900, comprising a computer processor to execute a set of program code instructions (see module 910) and modules for accessing memory to hold program code instructions to perform: invoking a global witness process on a first computing platform that communicates over one or more networks to at least one second computing platform and to at least one third computing platform (see module 920); listening on the network for occurrences of leadership requests from a plurality of requestors, wherein a leadership request comprises a last known state value (see module 930); queueing, in a first-in-first-out queue, incoming occurrences of leadership requests (see module 940); retrieving a queued leadership request and a respective last known state value (see module 950); comparing the respective last known state value to a stored state value (see module 960); storing a new state value when the respective last known state value is equal to the stored state value (see module 970); and rejecting the leadership request when the respective last known state value is not equal to the stored state value (see module 980).

Many embodiments or variations are possible, some of which embodiments or variations are given below:
Embodiments that further comprise sending the new state value to at least some of the requestors.
Embodiments that further comprise sending an affirmative acknowledgement to one of the requestors to generate a single leader, and sending a negative acknowledgement to the remaining requestors to generate a set of followers.
Embodiments wherein the single leader is a disaster recovery change transmitter.
Embodiments wherein at least one of the set of followers is a disaster recovery change listener.
Embodiments that further comprise sending a periodic liveness signal by the single leader.
Embodiments wherein at least some of the followers perform a liveness measure check.
Embodiments wherein comparing the respective last known state value to a stored state value retrieves the stored state value from a global database.
Embodiments wherein the global database comprises a global state table.
Embodiments wherein the first-in-first-out queue is a queueing facility to access the global database.

### System Architecture Overview

### Additional System Architecture Examples

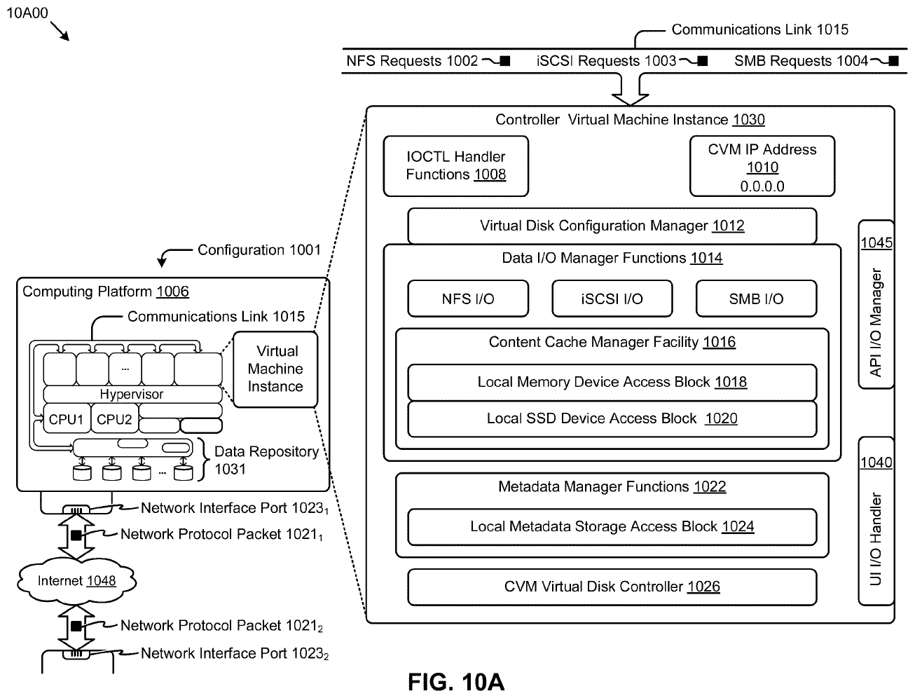

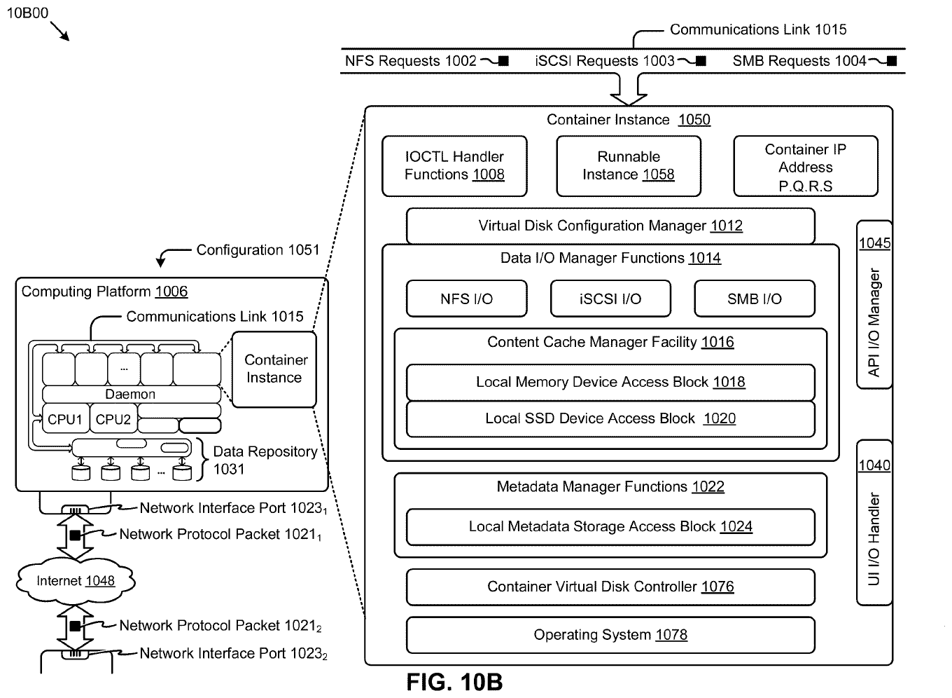

FIG. 10A depicts a virtual machine architecture 10A00 comprising a collection of interconnected components suitable for implementing embodiments of the present disclosure and/or for use in the herein-described environments. The shown virtual machine architecture 10A00 includes a virtual machine instance in a configuration 1001 that is further described as pertaining to the controller virtual machine instance 1030. A controller virtual machine instance receives block I/O (input/output or IO) storage requests as network file system (NFS) requests in the form of NFS requests 1002, and/or internet small computer storage interface (iSCSI) block IO requests in the form of iSCSI requests 1003, and/or Samba file system requests (SMB) in the form of SMB requests 1004. The controller virtual machine instance publishes and responds to an internet protocol (IP) address (e.g., see CVM IP address 1010. Various forms of input and output (I/O or IO) can be handled by one or more IO control handler functions (see IOCTL functions 1008) that interface to other functions such as data IO manager functions 1014, and/or metadata manager functions 1022. As shown, the data IO manager functions can include communication with a virtual disk configuration manager 1012, and/or can include direct or indirect communication with any of various block IO functions (e.g., NFS IO, ISCSI IO, SMB IO, etc.).

In addition to block IO functions, the configuration 1001 supports IO of any form (e.g., block IO, streaming IO, packet-based IO, HTTP traffic, etc.) through either or both of a user interface (UI) handler such as UI IO handler 1040 and/or through any of a range of application programming interfaces (APIs), possibly through the shown API IO manager 1045.

The communications link 1015 can be configured to transmit (e.g., send, receive, signal, etc.) any types of communications packets comprising any organization of data items. The data items can comprise a payload data area as well as a destination address (e.g., a destination IP address), a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases the payload comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions a data processor for execution. Such a medium may take many forms including, but not limited to, non-volatile media and volatile media. Non-volatile media includes, for example, solid-state storage devices (SSD), or optical or magnetic disks such as disk drives or tape drives. Volatile media includes dynamic memory such as a random access memory. As shown, the controller virtual machine instance 1030 includes a content cache manager facility 1016 that accesses storage locations, possibly including local DRAM (e.g., through the local memory device access block 1018) and/or possibly including accesses to local solid state storage (e.g., through local SSD device access block 1020).

Common forms of computer readable media includes any non-transitory computer readable medium, for example, floppy disk, flexible disk, hard disk, magnetic tape, or any other magnetic medium; CD-ROM or any other optical medium; punch cards, paper tape, or any other physical medium with patterns of holes, or any RAM, PROM, EPROM, FLASH-EPROM, or any other memory chip or cartridge. Any data can be stored, for example, in any form of external data repository 1031, which in turn can be formatted into any one or more storage areas, and which can comprise parameterized storage accessible by a key (e.g., a filename, a table name, a block address, an offset address, etc.). An external data repository 1031, can store any forms of data, and may comprise a storage area dedicated to storage of metadata pertaining to the stored forms of data. In some cases, metadata, can be divided into portions. Such portions and/or cache copies can be stored in the external storage data repository and/or in a local storage area (e.g., in local DRAM areas and/or in local SSD areas). Such local storage can be accessed using functions provided by a local metadata storage access block 1024. The external data repository 1031, can be configured using a CVM virtual disk controller 1026, which can in turn manage any number or any configuration of virtual disks.

Execution of the sequences of instructions to practice certain embodiments of the disclosure are performed by a one or more instances of a processing element such as a data processor, or such as a central processing unit (e.g., CPU1, CPU2). According to certain embodiments of the disclosure, two or more instances of configuration 1001 can be coupled by a communications link 1015 (e.g., backplane, LAN, PTSN, wired or wireless network, etc.) and each instance may perform respective portions of sequences of instructions as may be required to practice embodiments of the disclosure

The shown computing platform 1006 is interconnected to the Internet 1048 through one or more network interface ports (e.g., network interface port 1023₁ and network interface port 1023₂). The configuration 1001 can be addressed through one or more network interface ports using an IP address. Any operational element within computing platform 1006 can perform sending and receiving operations using any of a range of network protocols, possibly including network protocols that send and receive packets (e.g., see network protocol packet 1021₁ and network protocol packet 1021₂).

The computing platform 1006 may transmit and receive messages that can be composed of configuration data, and/or any other forms of data and/or instructions organized into a data structure (e.g., communications packets). In some cases, the data structure includes program code instructions (e.g., application code), communicated through Internet 1048 and/or through any one or more instances of communications link 1015. Received program code may be processed and/or executed by a CPU as it is received and/or program code may be stored in any volatile or non-volatile storage for later execution. Program code can be transmitted via an upload (e.g., an upload from an access device over the Internet 1048 to computing platform 1006). Further, program code and/or results of executing program code can be delivered to a particular user via a download (e.g., a download from the computing platform 1006 over the Internet 1048 to an access device).

The configuration 1001 is merely one sample configuration. Other configurations or partitions can include further data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor. Some embodiments include one or more special-purpose hardware components (e.g., power control, logic, sensors, transducers, etc.). A module may include one or more state machines and/or combinational logic used to implement or facilitate the operational and/or performance characteristics of scalable exclusive resource access using a centralized witness process in a multi-processing computing environment.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of scalable exclusive resource access using a centralized witness process in a multi-processing computing environment). Such files or records can be brought into and/or stored in volatile or non-volatile memory.

FIG. 10B depicts a containerized architecture 10B00 comprising a collection of interconnected components suitable for implementing embodiments of the present disclosure and/or for use in the herein-described environments. The shown containerized architecture 10B00 includes a container instance in a configuration 1051 that is further described as pertaining to the container instance 1050. The configuration 1051 includes a daemon (as shown) that performs addressing functions such as providing access to external requestors via IP address (e.g., “P.Q.R.S”, as shown), a protocol specification (e.g., “http:”) and possibly port specifications. The daemon can perform port forwarding to the container. A container can be rooted in a directory system, and can be accessed by file system commands (e.g., “Is” or “Is-a”, etc.). The container might optionally include an operating system 1078, however such an operating system need not be provided. Instead, a container can include a runnable instance 1058, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to a container virtual disk controller 1076. Such a container virtual disk controller can perform any of the functions that the aforementioned CVM virtual disk controller 1026, yet such a container virtual disk controller does not rely on a hypervisor or any particular operating system in order to perform its range of functions.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings to be regarded in an illustrative sense rather than in a restrictive sense.

What is claimed is:

1. A method comprising:
invoking a global witness process that communicates over one or more networks to at least two nodes in two or more computing clusters that comprise nodes that are connected to the one or more networks;
exposing a resource to be accessed by least the two nodes;
contacting, by a first node of the at least two nodes, the global witness process to establish ownership the resource;
determining, by a second node of the at least two nodes, that the second node is unable to contact the first node;
contacting, by the second node, the global witness process to determine that the first node is not operational; and
establishing, by the second node, new ownership of the resource.
